(19) United States
(12) Patent Application Publication
(10) Pub. No.: US 2019/0364962 A1
(43) Pub. Date: Dec. 5, 2019

(54) Stretch Net

(71) Applicant: David James Sanders, Morrison, TN (US)

(72) Inventor: David James Sanders, Morrison, TN (US)

(21) Appl. No.: 16/425,877

(22) Filed: May 29, 2019

Related U.S. Application Data
(60) Provisional application No. 62/677,522, filed on May 29, 2018.

(51) Int. Cl. A24F 13/12; A01K 77/00; A01K 75/00; A24F 13/08; B25J 1/06

(52) U.S. Cl. CPC A24F 13/12; A01K 77/00; B25J 1/06; A24F 13/08; A01K 75/00

(57) ABSTRACT

The present invention is a multi-functional hand tool that can be used in safely and securely retrieving and transporting fish, pet, and holding an object such as a cigarette or cigar for smoking without finger contact with the cigarette or cigar. The stretchable net of the present invention offers a user with a hoop and net of which the size can be changed by squeezing a pair of handles connected with a spring coil, thus, the user can retrieve large fish and hold the fish with a small opening by releasing the spring coil. The clip of the present invention has a jaw instead of a hoop and net. The jaw can be used to securely hold the cigarette or cigar by squeezing the handles and the user can use the clip for smoking without the user's fingers contacting the cigarette or cigar.

The current application claims a priority to the U.S. Provisional Patent application Ser. No. 62/677,522 filed on May 29, 2018.

### FIELD OF THE INVENTION

The present invention generally relates to tools for fishing, retrieving critters, and smoking. More specifically, the present invention is a hand tool with a pair of handles and a spring coil that can be used to stretch the opening size of a connected hoop or jaw. Thus, the present invention is a versatile hand-held tool that offers a user a variety of functions such as safely and securely retrieving fish during fishing, from an aquarium, transporting critters, holding a cigarette and/or cigar in place of fingers, etc.

### BACKGROUND OF THE INVENTION

A fish net is one of the most important tools that any fish keeper can have. From an aquarium such as a fish bowl, tank, container, or pond, a user may utilize the fish net to fish out uneaten food, sifting algae, debris floating on the surface, baby brine shrimp, mosquito larva, plant matter, of course, fish. It is difficult to catch fish, especially large fish, without using a fishing net. Whether the user is working with a seine of corral bait or intending to win a trophy, fishing nets are an integral part of the fishing experience.

The size of the fish net is very important for this use. Normally, the size of an aquarium net is measured horizontally across the mouth, i.e. perpendicular to the handle. The size of the net varies from less than two inches to over 10 inches. Additionally, an appropriate size for a specific application is critical. If the net is too big for the application, it may be easy to catch the fish. However, the big size net is hard to use for small fish. Additionally, the big size net is difficult for the user to steer around the aquarium and easy to accidentally bump plants, corals in the aquarium and causing damages. Further, if the net is too small for the application, the risk is that the fish may get injured and/or leap out of the net while moving it. Today, with advanced technologies used in the industry, fish nets have become easy, convenient, efficient, and portable for the user. Most existing nets, however, only have one size making the use very limited. The user may feel frustrated not having a net big enough in a time of need during fishing or having to keep multiple nets in the storage and carry them along in every trip.

It is an objective of the present invention to provide a solution for the aforementioned problems, drawbacks, and issues. The present invention offers a versatile tool for retrieving fish, small or large, from fishing, an aquarium, and/or any other suitable pet, critters, etc. The present invention comprises a stretchable net that has a hoop with variable opening sizes that can fit small and large fish or pet. The hoop size of the stretchable net can be controlled by squeezing a couple of handles connected with a spring coil. Squeezing the handles changes the hoop and net to a larger opening for the user to retrieve large fish. Once the large fish is netted, the user can easily retract back to a smaller hoop size to keep the fish from jumping out thereafter during transportation. Additionally, the versatile stretch net of the present invention protects the fish of all sizes by not forcing the fish in a hurry into a net that is too small for the size of the fish causing injury to the fish. Further, the present invention comprises a clip with the same structure as the stretchable net except for the hoop and net. The clip of the present invention comprises a jaw that is connected to the handles that can be squeezed to open the closed jaw to hold anything that the user desires. For example, the clip can be used to hold a cigarette or cigar for smoking without the user's fingers being in direct contact with the cigarette or cigar, thus eliminating the smell from the user's fingers. Further, the clip can be used to securely hold any other suitable object that the user desires. Thus, the present invention is a very efficient, inexpensive, convenient, and portable hand tool that offers multiple functions for the user's daily life.

### SUMMARY OF THE INVENTION

The present invention is a multi-functional hand tool, comprising a stretchable net and an object-holding clip. The stretchable net can be used in safely and securely retrieving and transporting fish during fishing or from an aquarium and pond, and pet or critters. The stretchable net of the present invention offers a user with a hoop and net of which the size is controlled by a user by squeezing a pair of handles connected with a spring coil. Thus, the user can retrieve large fish and hold the fish with a small opening by releasing the spring coil during transportation avoiding the fish jumping or flopping out of the net.

The clip of the present invention has the same structure of the stretchable net except for the hoop and net. Instead, the clip comprises a jaw that is held tightly closed by the spring coil when not in use. The clip can be used to hold any suitable object per the user's desire. For example, the user can use the clip to hold a cigarette or cigar for smoking by placing the cigarette or cigar between the jaw members while squeezing the handles. Releasing the handles, the user can conveniently use the clip to smoke the cigarette or cigar without finger being in direct contact with the cigarette or cigar. Thus, the present invention is a versatile hand-held tool that is efficient, convenient, portable, and inexpensive.

### BRIEF DESCRIPTION OF THE DRAWINGS

FIG. 1 is a perspective view of a stretch net of the present invention.

FIG. 2 is perspective view of the stretch net of the present invention with hoop and net being stretched.

FIG. 3 is a perspective view of a clip of the present invention.

### DETAIL DESCRIPTIONS OF THE INVENTION

All illustrations of the drawings are for the purpose of describing selected versions of the present invention and are not intended to limit the scope of the present invention.

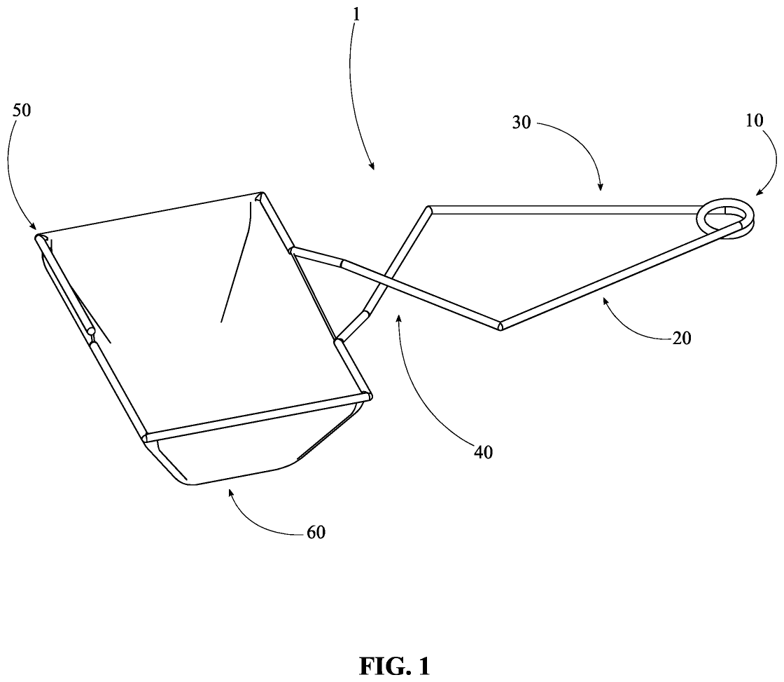

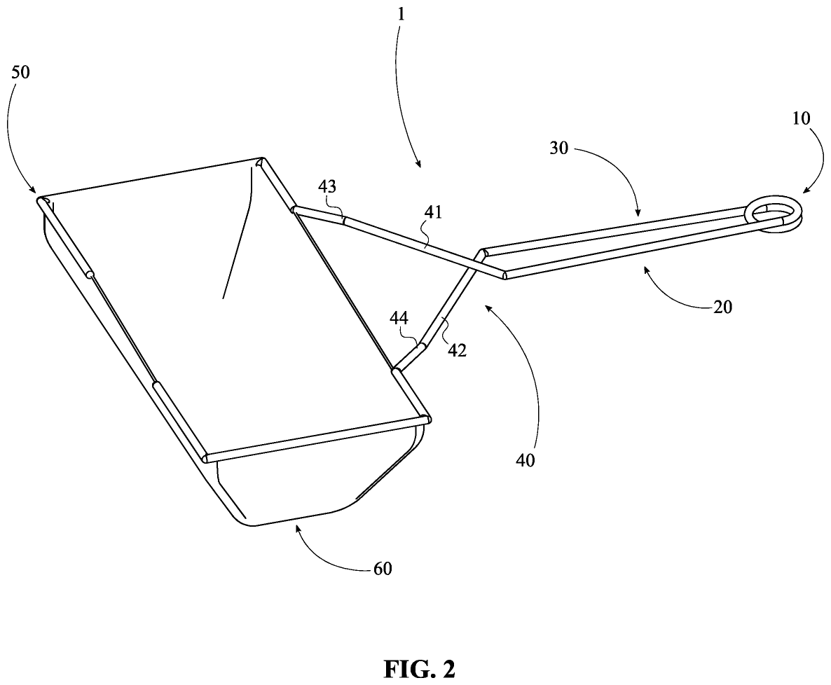

As illustrated in FIG. 1 to FIG. 2, in the preferred embodiment, the present invention comprises a stretch net 1 for safely and securely retrieving and transporting fish of various sizes during fishing or from an aquarium and pond, and pet or critters. The stretch net 1 of the present invention comprises a spring coil 10, a first handle 20, a second handle 30, a neck 40, a hoop 50, and a net 60. Specifically, the spring coil 10 is connected to the first handle 20 and the second handle 30, providing resistance force when a user squeezes the first handle 20 and second handle 30. Additionally, the spring coil 10 can be made of a suitable material including, but not limited to, steel, stainless steel, metal, aluminum, etc. Further, the spring coil can be made in any shapes and sizes for any suitable applications. The neck 40 is laterally stretchably connected to the first handle 20 and the second handle 30 opposite the spring coil 10. Specifically, the neck 40 connects the first handle 20 and the second handle 30 to the hoop 50. Additionally, the neck 40 can be the extension of the first handle 20 and the second handle 30. The hoop 50 is terminally connected to the neck 40 opposite the first handle 20 and the second handle 30. Specifically, the hoop 50 can be made into various shapes and sizes. Further, the net 60 is terminally connected to the hoop 50 and can be made of a material including, but not limited to, nylon, nylon coated cord, rubber, fabric, polymer, composite, plastic, etc. The mesh netting of the net 60 is can be fine, medium, or coarse, or any size. Additionally, the net 60 can be of a shape including, but not limited to, oval, rectangle, circle, flat-bottom, square, etc. Further, the stretch net 1 can be made into one continuous body including the spring coil 10, the first handle 20, the second handle 30, the neck 40, and the hoop 50. The stretch net 1 can also comprise separate components connected together. The material of making the stretch net 1 except for the net 60 can include, but is not limited to, steel, stainless steel, metal, aluminum, copper, metal wire, plastic, composite, corrosion resistance material, water resistance material, etc.

As illustrated in FIG. 1 to FIG. 2, the neck 40 of the stretch net a comprises a first crossing member 41 and a second crossing member 42. The first crossing member 41 comprises a deformation 43 and the second crossing member 42 comprises a deformation 44. More specifically, the first crossing member 41 is terminally positioned on the first handle 20 opposite the spring coil 10. The first deformation 43 is positioned on the first crossing member 41 adjacent the hoop 50. Further, the second crossing member 42 is terminally positioned on the second handle 30 opposite the spring coil 10. The second deformation 44 is positioned on the second crossing member 42 adjacent the hoop 50. When the user desires to stretch the hoop 50 and net 60 to made a large opening by squeezing the first handle 20 and the scone handle 30 altogether, the first deformation 43 of the first crossing member 41 and the second deformation 44 of the second crossing member of the neck 40 move away from each while the first handle 20 and the scone handle 30 moving toward each other. When the user releases the first handle 20 and the scone handle 30, the hoop 50 and the net 60 return to the original position by the spring force stored in the spring coil 10, thus the openings of the hoop 50 and the net 60 is smaller than the opening when the first handle 20 and the scone handle 30 are squeezed. Thus, the stretch net 10 can be stretched with a large opening for the user to scoop up a large fish and retracted back to have a small opening to hold the large fish for safe and secure transportation and storage.

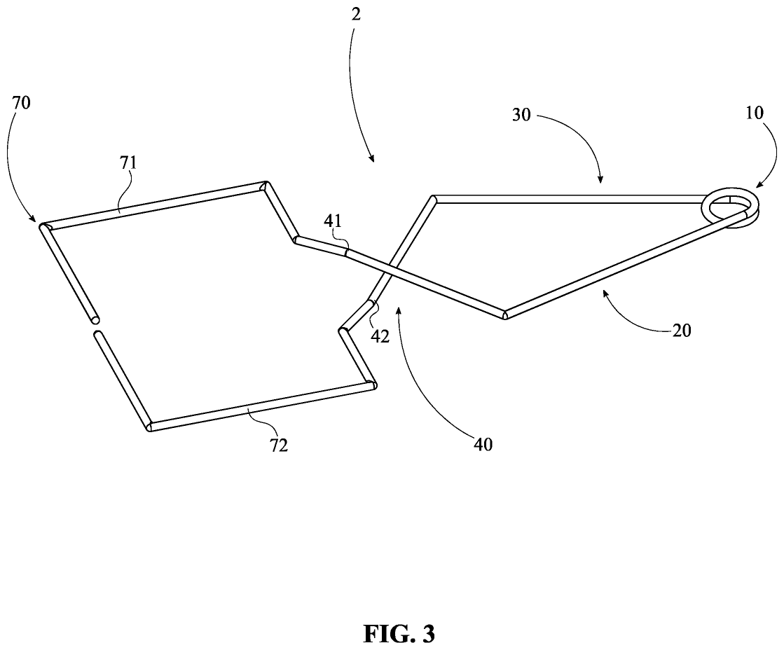

As illustrated in FIG. 3, in the preferred embodiment, the present invention comprises a clip 2 for safely and securely holding an object including, but not limited to, a cigarette or cigar for smoking. The clip 2 of the present invention comprises the spring coil 10, the first handle 20, the second handle 30, the neck 40, and a jaw 70. More specifically, the jaw comprises a first jaw member 71 and a second jaw member 72. The jaw is terminally connected to the neck opposite the first handle 20 and the second handle 30. Further, the first jaw member 71 is terminally connected to the first crossing member 41 of the neck 40, and the second jaw member 72 is terminally connected to the second crossing member 42 of the neck 40. Additionally, jaw 70 is closed with the spring force applied by the spring coil 10, and the first jaw member 71 and second jaw member 72 are separably in contact with each other to close the jaw 70. When in use, the user squeezes the first handle 20 and the second handle 30 to open the jaw. Subsequently, the user places a desired object in between the jaw member 71 and the second jaw member 72 and releases the first handle 20 and the second handle 30. The jaw 70 closes by the spring force of the spring coil 10. Thus, the user can hold the object within the jay 70 of the clip 2 without touching the object during the intended use, including, but not limited to, smoking a cigarette or cigar.

Although the invention has been explained in relation to its preferred embodiment, it is to be understood that many other possible modifications and variations can be made without departing from the spirit and scope of the invention as hereinafter claimed.

What is claimed is:

1. A stretch net for safely and securely retrieving and transporting fish of various sizes comprising:
a spring coil;
a first handle;
a second handle;
a neck;
a hoop;
a net;
the spring coil being connected to the first handle and the second handle;
the neck being laterally stretchably connected to the first handle and the second handle opposite the spring coil;
the hoop being terminally connected to the neck opposite the first handle and the second handle; and
the net being terminally connected to the hoop.

2. The stretch net for safely and securely retrieving and transporting fish of various sizes as claimed in claim 1, comprising:
the neck comprising a first crossing member and a second crossing member;
the first crossing member being terminally positioned on the first handle opposite the spring coil;
the second crossing member being terminally positioned on the second handle opposite the spring coil;
the first crossing member being terminally connected to the hoop adjacent the second handle; and
the second crossing member being terminally connected to the hoop adjacent the first handle.

3. The stretch net for safely and securely retrieving and transporting fish of various sizes as claimed in claim 2, comprising:
the first crossing member of the neck comprising a first deformation;
the second crossing member of the neck comprising a second deformation;
the first deformation being positioned adjacent the hoop; and
the second deformation being adjacent the hoop.

4. A clip for holding an object without touching the object during the intended use comprising:
a spring coil;
a first handle;
a second handle;
a neck;
a jaw;
the spring coil being connected to the first handle and the second handle;
the neck being connected to the first handle and the second handle opposite the spring coil;
the jaw being terminally connected to the neck opposite the first handle and the second handle.

5. The clip for holding an object without touching the object during the intended use as claimed in claim 4, comprising:
the neck comprising a first crossing member and a second crossing member;
the first crossing member being terminally connected to the first handle;
the second crossing member being terminally connected to the second handle;
the jaw comprising a first jaw member and a second jaw member;
the first jaw member being terminally connected to the first crossing member of the neck;
the second jaw member being terminally connected to the second crossing member of the neck; and
the first jaw member and the second jaw member being separably in contact with each other to close the jaw.
